(19) United States
(12) Patent Application Publication
(10) Pub. No.: US 2009/0125852 A1
(43) Pub. Date: May 14, 2009

(54) METHOD AND APPARATUS FOR NET-AWARE CRITICAL AREA EXTRACTION

(76) Inventor: EVANTHIA PAPADOPOULOU, Baldwin Place, NY (US)

Correspondence Address: Patterson & Sheridan, LLP, 595 Shrewsbury Avenue - Suite 100, Shrewsbury, NJ, 07702, US

(21) Appl. No.: 11/937,644

(22) Filed: Nov. 9, 2007

(51) Int. Cl. G06F 17/50

(52) U.S. Cl. 716/4; 716/11

(57) ABSTRACT

In one embodiment, the present invention is a method and apparatus for net-aware critical area extraction. One embodiment of the inventive method for determining the critical area of an integrated circuit includes modeling a net corresponding to the integrated circuit as a graph, the net comprising a plurality of interconnected shapes spanning one or more layers of the integrated circuit, identifying one or more core elements in the graph, the core elements including bridges, articulation points, and biconnected components, computing a first Voronoi diagram for a core portion of the graph on a selected layer, including the core elements, emphasizing regions in the first Voronoi diagram where a critical radius is known, computing a second, higher-order Voronoi diagram in accordance with the emphasized regions, and computing the critical area in accordance with the higher-order Voronoi diagram.

### BACKGROUND

The present invention relates generally to very-large-scale integration (VLSI) devices, and relates more particularly to predicting the yield of VLSI chips.

Critical area is a measure of the sensitivity of a VLSI chip design to random particle defects and is widely used to predict the yield of a VLSI chip in the presence such defects. For example, extra material defects may cause shorts (short circuits) between different conducting regions, while missing material defects may cause opens (open circuits). The latter case occurs when a conducting path is broken into two or more pieces. To reduce the occurrence of opens, many VLSI chip designers insert redundant interconnects (loops) in their designs. These loops provide alternate routes that allow a circuit to remain connected in the presence of defects that might otherwise cause an open. At the same time, however, the loops increase the potential for shorts. Accurate critical area computation is essential in balancing these competing concerns.

Accurate and efficient computation of critical area is therefore very important in integrated circuit (IC) manufacturing, especially when design for manufacturability (DFM) initiatives are a consideration. Conventional tools for computing critical area, however, fail to account for the loops described above, and thereby overestimate the actual critical area for opens while (correctly) registering an increase in critical area for shorts. This is because these tools assume that interconnects are routed in a tree fashion, and thus any defect that breaks any conducting path is assumed to create an open. As a result, designs incorporating loops are erroneously penalized.

Thus, there is a need in the art for a method and apparatus for net-aware critical area extraction.

### SUMMARY OF THE INVENTION

In one embodiment, the present invention is a method and apparatus for net-aware critical area extraction. One embodiment of the inventive method for determining the critical area of an integrated circuit includes modeling a net corresponding to the integrated circuit as a graph, the net comprising a plurality of interconnected shapes spanning one or more layers of the integrated circuit, identifying one or more core elements in the graph, the core elements including bridges, articulation points, and biconnected components, computing a first Voronoi diagram for a core portion of the graph on a selected layer, including the core elements, emphasizing regions in the first Voronoi diagram where a critical radius is known, computing a second, higher-order Voronoi diagram in accordance with the emphasized regions, and computing the critical area in accordance with the higher-order Voronoi diagram. Thus, the present invention computes iteratively higher-order Voronoi diagrams until the final Voronoi diagram for opens is derived. In each iteration, new regions of the current Voronoi diagram are emphasized.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary simple net that spans two metal layers;

FIG. 2 is a schematic diagram illustrating the exemplary simple net of FIG. 1, this time including a plurality of defects that cause breaks (and consequently opens) and a plurality of defects that cause no breaks (and thus are not considered faults);

FIG. 3 is a flow diagram illustrating one embodiment of a method for computing the critical area of a net;

FIG. 4 is a schematic diagram illustrating an expanded graph for the exemplary net of FIG. 1;

FIG. 5 is a schematic diagram illustrating the expanded graph for the exemplary net of FIG. 1, where all simple bridges, simple articulation points, and simple biconnected components have been removed from the extended graph, and thus all remaining bridges, articulation points and biconnected components are “net”;

FIG. 6 is a schematic diagram illustrating the weighted Voronoi diagram, V(Cᵢ), for the exemplary net of FIG. 1;

FIG. 7 is a schematic diagram illustrating a weighted Voronoi diagram of all core elements on a given layer of the exemplary net of FIG. 1;

FIG. 8 is a schematic diagram illustrating the second-order Voronoi diagram of the Voronoi diagram illustrated in FIG. 7; and

FIG. 9 is a high level block diagram of the present critical area computation method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for net-aware critical area extraction. Embodiments of the invention compute a first Voronoi diagram based on a graph that represents a net (where the net corresponds to the circuit for which critical area is to be determined). An iterative process then computes successively higher-order Voronoi diagrams, emphasizing regions of the Voronoi diagrams as critical radii are identified, until a final Voronoi diagram for opens is derived. The iterative process may be stopped either when all regions of the current Voronoi diagram are emphasized to indicate that critical radius in those regions is known, or when a user-specified limit on number of iterations is reached (in which case, regions of the last Voronoi diagram may remain un-emphasized). In the latter case, the Hausdorff Voronoi diagram of cuts computed so far is computed, and the final Voronoi diagram for opens is derived from the Hausdorff Voronoi diagram.

In one embodiment, the present invention is a method and apparatus for net-aware critical area extraction. Specifically, the method and apparatus of the present invention provide a net-aware means of accurately computing critical area for opens, even in the presence of loops. By net-aware, it is meant that a defect forms a fault if it is actually breaking a net (i.e., the net's terminal points are disconnected). In one embodiment, the problem of computing critical area is modeled as a graph problem and solved efficiently by exploiting the geometric nature of the graph problem.

The critical area of a circuit layout on a layer A of an IC is defined as:

A_{c}=∫₀^{∞}A(r)D(r)dr (EQN. 1)

where A(r) denotes the area in which the center of a defect of radius r must fall in order to cause circuit failure, and D(r) is the density function of the defect size.

Critical area analysis is typically performed on a per-layer basis, and results from all layers are combined to estimate the total yield of the IC design. The defect density function, D(r), may be estimated as:

$$D ( r ) = \{ \begin{matrix}{cr}^{q} / {r}_{0}^{q + 1} , & 0 \leq r \leq {r}_{0} \\ {cr}_{0}^{p - 1} / {r}^{p} , & {r}_{0} \leq r \leq ∞\end{matrix} \qquad ( EQN . 2 )$$

where p and q are real numbers (typically, p=3 and q=1), c=(q+1)(p−1)/(q+p) and r₀ is some minimum optically resolvable size. Using the typical values for p, q and c, one can derive the widely used defect size distribution, D(r)=r₀²/r³ (r₀ is typically smaller than the minimum feature size, thus D(r) is ignored for r<r₀). In accordance with common practice, to facilitate critical area computation, a defect of size r is herein modeled as a square of radius r (i.e., a square of side 2r).

For simplicity of computation and presentation, the known L∞ metric has been adapted herein in a manner consistent with the common practice of modeling defects as squares to facilitate critical area computation. It is thus assumed that, given a layer, A, of an PATENT integrated circuit (IC), overlapping shapes have been unified into disjoint polygons (where a polygon may be simple, or alternatively may contain holes if same-layer loops are present). With this is mind, a “defect”, D, is defined as a “minimal break” of a simple shape, P, if: (1) the defect, D, breaks the shape, P, into at least two pieces; and (2) the defect, D, has minimal size (i.e., if the defect, D, is shrunk by ε≧0, then the defect, D, will be entirely contained within the interior of the shape, P). A piece of the shape, P, may trivially consist of a single edge. A minimal break is considered to be “strictly minimal” if it contains no other minimal break in its interior. A “break” is any defect that totally overlaps a minimal break.

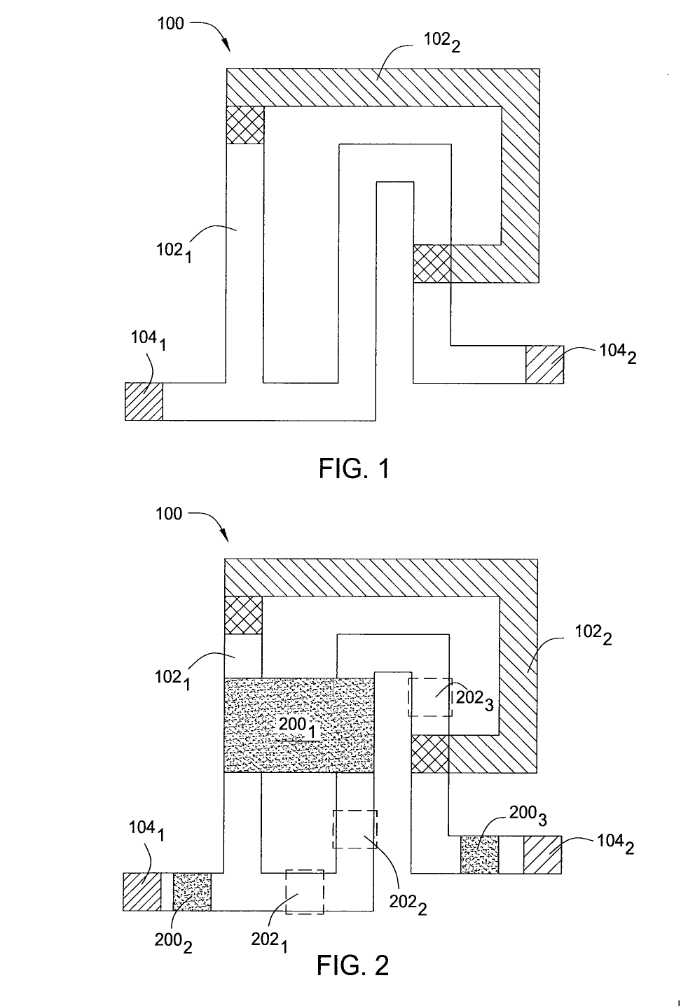

FIG. 1 is a schematic diagram illustrating several concepts associated with the present invention. Specifically, FIG. 1 illustrates an exemplary simple net 100 that spans two metal layers 102₁-102₂ (hereinafter collectively referred to as “layers 102”). Further, for the purposes of the present invention, a “net” such as the net 100 is defined, from an IC layout perspective, as a collection of interconnected shapes that span a number of layers of the IC. These shapes are “terminal shapes” if they represent entities that must be interconnected by the net (e.g., power buses, gates, sources and drains of transistors, pins of macros or other user-defined entities, among others). For example, in FIG. 1, the simple net 100 comprises two terminal shapes 104₁-104₂ (hereinafter collectively referred to as “terminal shapes 104”).

A “minimal open” is defined herein as a defect, D, that breaks a net, N, where the defect, D, has minimal size (i.e., if the defect, D, is shrunk by ε>0, then the defect, D, no longer breaks the net, N). The defect, D, breaks the net, N, if any two terminal shapes in the net, N, become disconnected or if at least one terminal shape in the net, N, is broken. A minimal open is “strictly minimal” if it contains no other minimal open in its interior. An “open” is any defect, D, that entirely covers a minimal open.

As long as all terminal shapes comprising a net remain interconnected, the net is considered to be functional; otherwise, the net is considered to be broken. Thus, if a defect disconnects a piece of the net that contains no terminal shapes, the defect should not be considered a fault (because the net is not broken). A defect may cause a net to break in two ways: (1) the defect breaks all possible paths along the net between two terminal shapes; or (2) the defect breaks (i.e., destroys) a terminal shape itself. FIG. 2 is a schematic diagram illustrating the exemplary simple net 100, this time including a plurality of defects 200₁-200₃ (hereinafter collectively referred to as “defects 200”) that cause opens and a plurality of defects 202₁-202₃ (hereinafter collectively referred to as “defects 202”) that cause breaks on the shape of layer M1 but cause no opens (and thus are not considered faults). As illustrated, the defects 200 that do cause opens each affect all possible paths between the terminal shapes 104, while the defects 202 that do not cause opens each affect less than all possible paths. It is noted that while the defects 202 do not create opens (as they do not break the net 100), the defects 202 do break wires of the layer 102,.

The center of an open, D, is herein referred to as a “generator point” and is weighted with the size (radius) of the open, D. A generator point is “strictly minimal” if it is the center of a strictly minimal open. If a defect, D, creates an open by breaking a single polygonal path (interconnect), the generator point is referred to as a “first order generator point”. If the opens are strictly minimal, then the generator segment is also referred to as “strictly minimal”. Herein, the term “generator” will be used to refer to both generator points and generator segments.

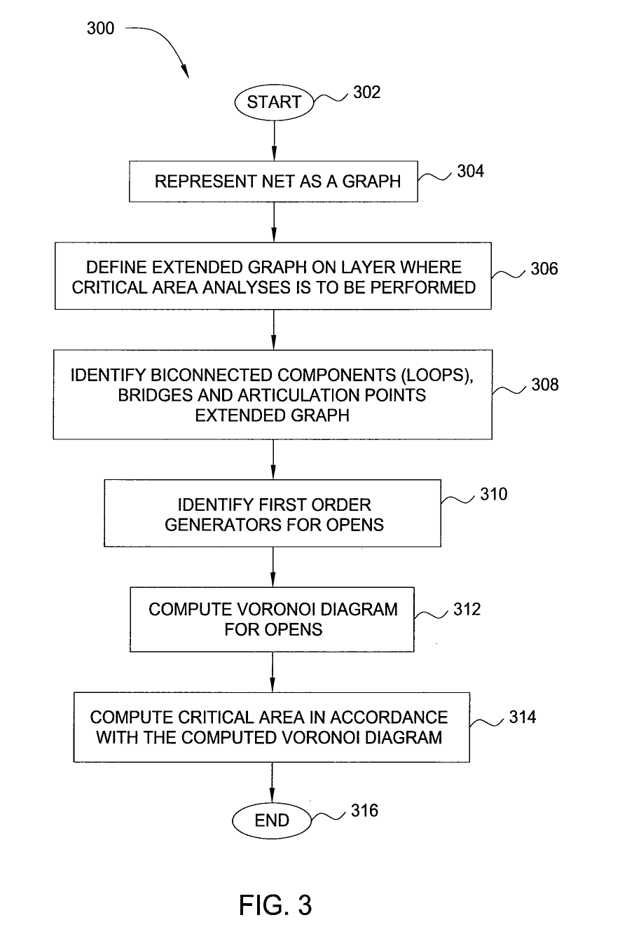

FIG. 3 is a flow diagram illustrating one embodiment of a method 300 for computing the critical area of a net, N. The method 300 relies in part on the concept of Voronoi diagrams, as described in greater detail by E. Papadopoulou in “Critical Area Computation for Missing Material Defects in VLSI Circuits”, IEEE Transactions on Computer-Aided Design, vol. 20, no. 5, pp. 583-597, 2001, which is herein incorporated by reference in its entirety. As defined therein, the Voronoi diagram of a set of polygonal sites in a plane is a partitioning of the plane into regions (called “Voronoi regions”), one region for each polygonal site, such that the Voronoi region of a site, s, is the locus of points closer to the site, s, than to any other site. The Voronoi region of the site, s, is denoted as reg(s), and the site, s, is called the “owner” of the Voronoi region, reg(s). The boundary that borders two Voronoi regions is called a Voronoi edge and comprises portions of bisectors between the owners of the neighboring Voronoi regions. The bisector of two polygonal objects (e.g., points, segments, polygons, etc.) is the locus of points equidistant from the two polygonal objects. The point where three or more Voronoi edges meet is called a “Voronoi vertex”. The combinatorial complexity of the Voronoi diagram is linear in the number and complexity of the sites. In the interior of a simple polygon, the Voronoi diagram is also called a “medial axis”. Any point, p, on the boundary of the region, reg(s), is weighted by w(p)=d(p,s). The disk, D, centered at the point, p, of radius w(p) is empty (i.e., no site intersects the interior of the disk, D).

The L∞ distance between two points, p=(xₚ,yₚ) and q=(x_{q},y_{q}) is d(p,q) =max{|xₚ−x_{q}|, |yₚ−y_{q}|}. In the presence of additive weights, the (weighted) distance is d_{w}(p, q)=d(p, q)+w(p)+w(q), where w(p) and w(q) denote the weights of points p and q, respectively. In the case of a weighted line, l, the (weighted) distance between the points t and l is dw(t, l)=mind(t, q)+w(q), ∀qεl}. The (weighted) bisector between polygonal elements sᵢ and sⱼ is b(sᵢ, sⱼ)={y|d_{w}(sᵢ, y)=d_{w}(sⱼ, y)}.

The term “core element” as used herein refers to either a core segment or a core point and denotes a portion of interest along a bisector (e.g., a medial axis segment, a Voronoi edge, or a Voronoi vertex). In L∞, core segments can be treated as additively weighted ordinary segments. If s is a core segment induced by the polygonal elements eₗ, eᵣ (i.e., s is a portion of bisector b(eₗ, eᵣ). Every point, p, along the core segment, s, is weighted with w(p)=d(p, eₗ)=d(p, eᵣ). The forty-five degree rays (i.e., rays of slope ±1) emanating from the endpoints of the core segment, s, partition the plane into the regions of influence of either the open core segment or the core endpoints. In the region of influence of a core point, p, distance is essentially measured in the ordinary weighted sense (i.e., for any point, t, d_{w}(t, p)=d(t, p)+w(p)). In the region of influence of an open core segment, s, distance is essentially measured according to the farthest polygonal element defining the core segment, s (i.e., d_{w}(t,s)=d(t,eₗ), where eₗ is the polygonal element at the opposite side of the line through the core segment, s, than the point, t. In L∞, this is equivalent to the ordinary weighted distance from the core segment, s. The bisector between two core elements (and therefore the Voronoi diagram of a set of core elements), can then be defined as usual. The (weighted) Voronoi diagram of core medial axis segments is a solution to the critical area computation problem for a simpler notion of breaks (i.e., opens based solely on geometric information).

If a defect, D, creates an open by overlapping a number, k, of distinct core elements of core(A), the defect is herein referred to as a “k^{th} order generator point”. A segment formed as a union of k^{th} order generator points for opens is herein referred to as a “k^{th} order generator segment”. In the case of core elements equidistant (in a weighted sense) from the center of the defect, D, a k^{th} order defect is allowed to overlap more than k wire segments.

The net, N, includes a layer, X, where the portion of the net, N, along the layer, X is denoted as N_{X}=N∩X. The portion, N_{X}, of the net, N, consists of a number of connected components Nₓ_{ₗ}, . . . . , N_{X}_{ₖ}, k≧1 interconnected through different layers. A connected component of the net, N, on the layer, X, is a collection of overlapping polygons that can be unioned to a single shape (a simple shape or a shape with holes). For simplicity, it can be assumed that all overlapping shapes on the layer, X, have been unioned into disjoint polygons. If there are terminal shapes among the overlapping shapes, terminal information is maintained on the edges of unioned polygons that are induced by the terminal shapes, and these edges are referred to as “terminal edges”.

Referring back to FIG. 3, the method 300 is initialized at step 302 and proceeds to step 304, where the method 300 represents the net, N, as a graph. In one embodiment, the net, N, is represented as a compact graph, G(N), by first representing every connected component (polygon) of the net, N, that occurs on a conducting layer (metal, poly, etc.) as a graph node. Two nodes are connected by an edge if and only if there is at least one contact or via connecting the components represented by the nodes. Nodes representing terminal shapes are identified as “terminal nodes”. There will exist at least one node for every conducting layer on which the net, N, expands. In one embodiment, the compact graph G(N), is built using some net extraction capability; it is assumed herein for simplicity of explanation that a compact graph is available for any net.

In step 304, the method 300 defines an extended graph, G(N, A), of the net, N, on a layer, A, where critical area analysis is to be performed. In one embodiment, the graph, G(N), is extended to G(N, A) by first expanding every component of the net, N, on the layer, A, by the component's medial axis. In addition, for every via or contact that connects a component of portion N_{A} to a component of portion N_{B} (B≠A), an approximate point representing that via or contact (hereinafter referred to as a “via-point”) is introduced along the medial axis. Finally, edges of the extended graph, G(N, A) are introduced to connect via-points to nodes of components of N_{B}.

In intuitive terms, vias or contacts are mapped to specific medial axis points, and edges are introduced to represent electrical contacts between N_{B}_{ⱼ} and N_{A}_{ᵢ}. In the presence of via clusters (i.e., groups of adjacent vias connecting N_{B}_{ⱼ} and N_{A}_{ᵢ}, one via-point can be used to represent the middle of the entire group of redundant vias. If a via or contact has been designated as a terminal shape, the corresponding via-point along the medial axis is also designated as terminal.

If N_{A}_{ᵢ} contains terminal shapes, then the portions of the medial axis induced by edges of terminal shapes (terminal edges) are identified and marked as terminal. The extended graph, G(N, A), can be regarded as an ordinary graph with two types of nodes: (1) the net-component nodes of G(N−N_{A}) (i.e., graph nodes representing components of the net, N, except for the components of N_{A}); and (2) the medial axis vertices and via-points of the components of N_{A}. The edges of the extended graph, G(N, A) can be partitioned into three types: (1) graph edges of G(N) that connect net-component nodes of G(N−N_{A}); (2) new graph edges that connect a net component node to a via-point on N_{A}; and (3) medial axis edges on N_{A} that connect medial axis vertices and via-points. Some of the nodes, and even some entire medial axis edges, are designated as terminal. When critical area analysis on the layer, A, is performed, edges of the third type are only vulnerable to defects on layer A. All other edges are unbreakable with respect to layer A.

FIG. 4, for example, is a schematic diagram illustrating an expanded graph, G(N, A) for the exemplary net 100 of FIG. 1, where A=layer 102₁. The terminal points 104 are indicated by hollow circles. The dashed lines merely represent the original polygon of the layer 102₁, and are not part of the extended graph G(N, 102₁). The dark circles and arcs represent ordinary vertices and edges of the expanded graph, G(N, A).

Referring back to FIG. 3, once the extended graph, G(N, A), has been defined, the method 300 proceeds to step 308 and identifies or detects biconnected components (loops), bridges and articulation points in the extended graph. Loops are revealed by biconnected components of the graph. Given a layer, A, and any defect, D, one can determine whether the defect, D, breaks the net, N (i.e., whether the defect, D, breaks or disconnects one or more terminals of the net, N). In one embodiment, this is accomplished by partitioning the extended graph, G(N, A) into biconnected components, bridges and articulation points using depth-first search (DFS), for example as described in greater detail by J. Hopcroft et al. in “Efficient Algorithms for Graph Manipulation”, Comm. ACM, vol. 16, no. 6, pp. 372-378, 1973, and R. Tarjan in “Depth-First Search and Linear Graph Algorithms”, SIAM Journal on Computing, 1, 1972, 146-159, both of which are herein incorporated by reference. A biconnected component of a connected, undirected graph, G, is defined as a maximal set of edges such that any two edges in the set lie on a common simple cycle. A bridge of a graph, G, is defined as an edge whose removal disconnects the graph, G. An articulation point of a graph, G, is defined as a vertex whose removal disconnects the graph, G. Further, a “net bridge” or a “net articulation point” is an edge or vertex, respectively, whose removal disconnects the extended graph, G(N, A), leaving terminals on both sides. Ordinary bridges and articulation points that do not disconnect terminals are referred to as “simple bridges” and “simple articulation points”. Terminal articulation points are net articulation points.

If G_{π}(N, A) denotes a DFS tree of the extended graph, G(N, A), it is well-known that the DFS tree, G_{π}(N, A), can give a decomposition of the extended graph, G(N, A) into bridges, articulation points and biconnected components in linear time. For the purpose of extracting critical area, one need only maintain some additional terminal information to determine whether the removal of a vertex or an edge actually breaks the extended graph, G(N, A). For this purpose, in one embodiment, every node i in the DFS tree, G_{π}(N, A), maintains a flag indicating whether the subtree rooted at the node, i, contains a terminal point. In addition, a terminal node or terminal point is chosen as the root of the DFS tree, G_{π}(N, A).

Assuming that the root of the DFS tree, G_{π}(N, A), is a terminal node, one can easily determine whether a bridge or an articulation point is “net” or “simple”, given the stored terminal information at the nodes, i. Simple (or “trivial”) articulation points and simple (or “trivial”) bridges, as well as any potential biconnected component that does not contain a terminal point or a net articulation point (referred to as a “simple biconnected component”), can be removed with no effect on the net connectivity regarding opens (i.e., removal does not disconnect terminals of the extended graph, G(N, A)). “Net” bridges or articulation points comprise bridges or articulation points whose removal results in a fault.

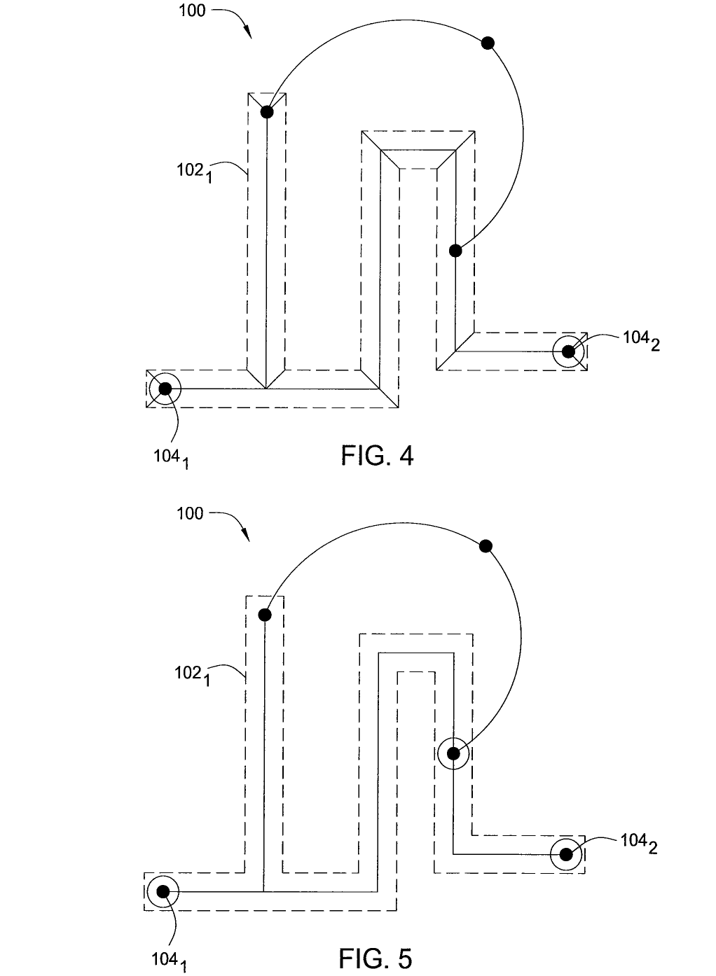

FIG. 5 is a schematic diagram illustrating the expanded graph, G(N, A) for the exemplary net 100 of FIG. I (i.e., as illustrated in FIG. 4), where all simple bridges, simple articulation points, and simple biconnected components (as illustrated in FIG. 4) have been removed from the extended graph, G(N, A), and thus all remaining bridges, articulation points and biconnected components are “net”. Circles indicate net terminal points and net articulation points. The expanded graph, G(N, A) includes one bi-connected component.

The core of the extended graph, G(N, A), on the layer, A, must be determined. The core(N, A) is the set of all medial axis vertices, including articulation, via and terminal points, and all medial axis edges, excluding all standard forty-five-degree edges (i.e., all forty-five degree medial axis edges corresponding to bisectors of axis-parallel polygon edges). It is assumed that all trivial components, trivial bridges and trivial articulation points have been removed from the extended graph, G(N, A). The union of core(N, A) for all nets, N, is denoted as core(A).

Referring back to FIG. 3, once the loops have been detected in the extended graph, G(N, A), the method 300 proceeds to step 310 and identifies first-order generators for opens within the extended graph, G(N, A). The set of first-order generators, G₁(N, A), for strictly minimal opens on the layer, A, are the bridges, terminal edges, articulation points and terminal points of G(N, A) ∩ core(N, A) for every net, N.

A “cut” is a collection of core elements C⊂core(N, A), such that G(N, A)−C is disconnected, leaving non-trivial (i.e., net) articulation or terminal points in at least two difference sides. A cut, C, of k elements is designated as minimal if CD−{c} is not a cut for any element cεC.

A core segment is assumed to consist of three distinct core elements: two endpoints and one open line segment. Given a net, N, the core(N, A) induces a unique decomposition of the portion of the net, N, on the layer, A, into well-defined wire segments. Those wire segments may overlap, and their union reconstructs NA (excluding the trivial portions of N_{A}). In particular, any core element, s, induces a wire segment, R(s)=∪_{pεs}R(p), where R(p) denotes the disk (the square in L∞) of radius w(p) centered at the core point, p. In FIG. 5, all depicted medial axis vertices and segments constitute core(N, A). The dark shaded disks of FIGS. 1 and 2 are strictly minimal opens.

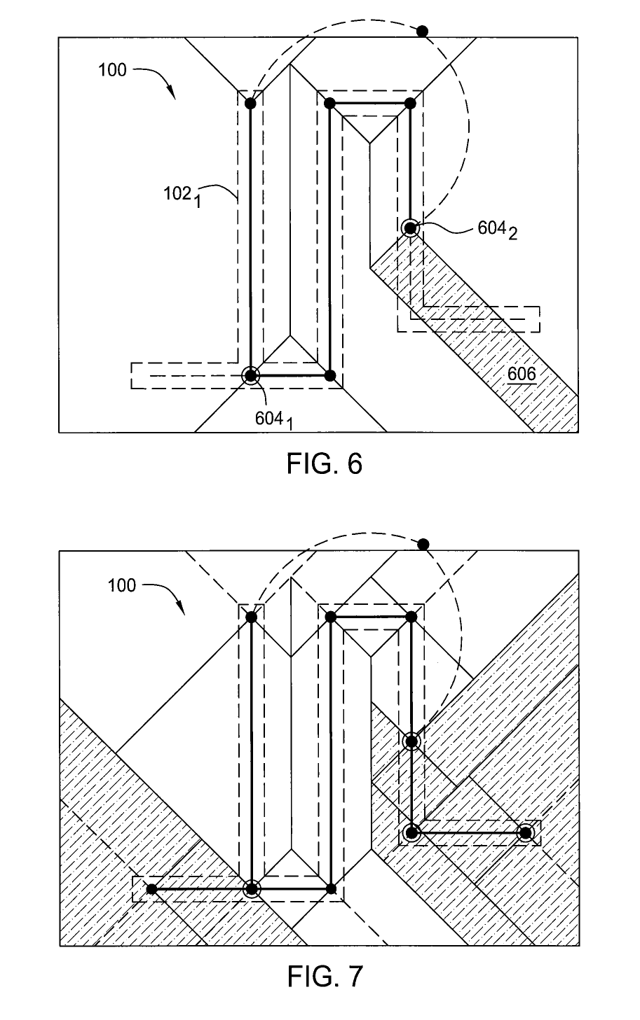

FIG. 6, for example, is a schematic diagram illustrating the weighted Voronoi diagram, V(A), for the exemplary net 100 of FIG. 1. The net 100 contains exactly one biconnected component, Cᵢ. The weighted Voronoi diagram, V(A), contains two articulation points 604₁ and 604₂. Region 606 belonging to first order generators is shaded. FIG. 7 is a schematic diagram illustrating a weighted Voronoi diagram, V(A), of all core elements on layer, A, for the net, N.

Once the biconnected components and first-order generators for opens have been identified, the method 300 proceeds to step 312 and computes the Voronoi diagram for opens (on the layer, A). The Voronoi diagram for opens is a subdivision of the layer, A, into regions such that each region reveals the critical radius for opens for every point in the region. It is recalled that the critical radius of a point t, r_{c}(t), is the size of the smallest defect centered at the point, t, and causing a circuit failure. A circuit failure here corresponds to an open. For any point, t, in a region, reg(h), of the Voronoi diagram for opens, the critical radius, r_{c}(t), of the point, t, should be derived as a distance function from the owner, h, namely, r_{c}(t)=d_{w}(t, h) for hεcore(A).

In one embodiment, the (weighted) Voronoi diagram, V(A), of all core segments on the layer, A, is considered. If there are no loops associated with the layer, A, then all elements of core(A) must be first-order generators for opens, and V(A) must provide the Voronoi diagrams for opens on the layer, A. Referring back to FIG. 7, FIG. 7 illustrates the net graph of FIGS. 1 and 2. To model opens appropriately, one embodiment of the present invention follows some additional conventions for the (weighted) Voronoi diagram, V(A), as follows: (1) A region equidistant from a core segment and the core segment's endpoint is always assigned to the endpoint; and (2) All regions of first-order are (visually) emphasized. Emphasizing a region indicates that the critical radius of every point in the region is determined by the owner of that region.

The order-k Voronoi diagram of the layer, A, is denoted as V^{k}(A). For k=1, V^{k}(A)=V(A). A non-emphasized region of the order-k Voronoi diagram, V^{k}(A), is a locus of points with the same k nearest neighbors (in a weighted sense) among the core elements in core(A). A emphasized region of the order-k Voronoi diagram, V^{k}(A), is a locus of points with the same r (1≦r≦k) nearest neighbors among the core elements in core(A), such that the set, C, of those r core elements constitutes a minimal cut for some net, N. If |C|>1, the emphasized Voronoi region, reg (C), is further subdivided into finer subregions by the farthest Voronoi diagram of C, denoted as V_{f}(C).

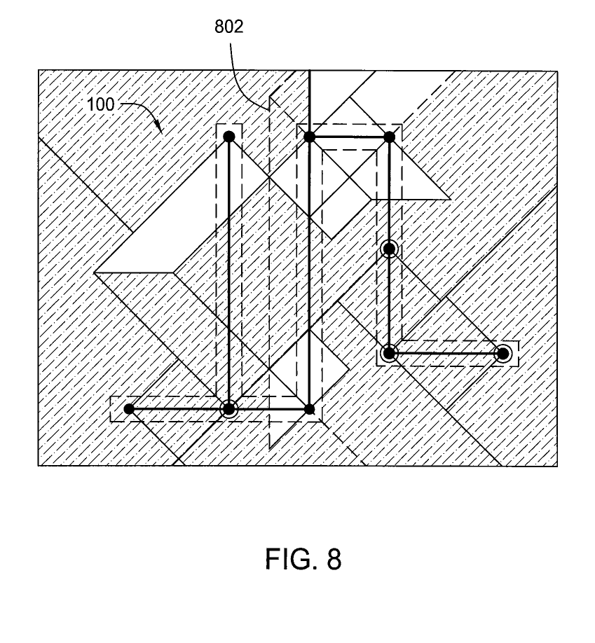

FIG. 8 is a schematic diagram illustrating the second-order Voronoi diagram, V²(A), of the Voronoi diagram, V(A), illustrated in FIG. 7. Voronoi regions of the second-order Voronoi diagram, V²(A), are illustrated in solid lines, and emphasized regions are illustrated as shaded. Thick dashed lines indicate the farthest Voronoi diagram of C, V_{f}(C), for cuts C, |C|=2.

There are two types of emphasized regions in the order-k Voronoi diagram, V^{k}(A): (1) regions that are expanded emphasized regions of the order-k-1 Voronoi diagram, V^{k-1}(A), referred to as “old emphasized regions”; and (2) “new emphasized regions” of cuts determined in the order-k Voronoi diagram, V^{k}(A). Any emphasized region of the order-k Voronoi diagram, V^{k}(A), remains emphasized in the order-k+1 Voronoi diagram, V^{k+1}(A). The second-order generators 802 for minimal opens are also illustrated as a thick, dashed, axis-parallel line, and the regions in which the second-order generators 802 for minimal opens 802 occur are new emphasized regions.

The Voronoi diagram for opens on layer A is the minimum order-k Voronoi diagram of core(A), V^{k}(A), such that all regions of the order-k Voronoi diagram, V^{k}(A), are emphasized. Any Voronoi region reg(H) such that H consists of more than one core element is further subdivided into finer regions by V_{f}(H), the farthest Voronoi diagram of H. The critical radius for any point, t, in a Voronoi region reg(H) is r_{c}(t)=max{d_{w}(t, h), hεH). In particular, if the point, t, is in the subregion reg(h)⊂reg(H)∩V_{f}(H), then r_{c}(t)=d_{w}(t, h).

Moreover, the higher order generators for strictly minimal opens on layer A are exactly the farthest Voronoi edges and vertices (except the standard forty-five degree Voronoi edges) of the opens Voronoi diagram on layer A constituting the farthest Voronoi subdivisions in the Voronoi region of any cut C of size |C|>1.

In one embodiment, a simple iterative process is used to obtain the Voronoi diagram for opens. Specifically, the iterative process obtains a higher order Voronoi diagram of points, as the interest here is primarily in small values of k. The main difference with the standard case of points is that an open core segment, s, does not exist in the region of the open core segment's endpoint, p. That is, the open core segment, s, cannot be considered as a higher order nearest neighbor in reg(p). Furthermore, in Loo, there can be regions equidistant from more than one element. As a result, unlike the Euclidean metric, the k-tuples owning two neighboring Voronoi regions may differ in more than one element.

In one embodiment, the weighted Voronoi diagram, V(A), is first obtained by plane sweep modifying the algorithm taught by Papadopoulou et al. in “The L∞ Voronoi Diagram of Segments and VLSI Applications,”, International Journal of Computational Geometry and Applications, 11(5), 2001, pp. 503-528, which is herein incorporated by reference in its entirety. Specifically, the algorithm is modified to accommodate weights and the convention of assigning priority to endpoints (as opposed to assigning priority to the open portion of segments). The weights are incorporated to ensure no disconnected Voronoi regions in the weighted Voronoi diagram, V(A). In one embodiment, the priority assignment convention is accommodated by modifying the original algorithm to include the bisectors (forty-five degree rays in L∞) between the open portion of core segments and their endpoints, or by drawing the additional bisectors in linear time after the original weighted Voronoi diagram, V(A), is constructed. Intersections among the additional bisectors can be resolved arbitrarily. All Voronoi subregions associated with the same core point, p, are unified into a single Voronoi region for the core point, p. The properties and the asymptotic combinatorial complexity of the Voronoi diagram remain substantially the same.

It is assumed that V^{k}(A) (k≧1) is available. V^{k+1}(A) can be computed from V^{k}(A) by first letting reg(H) be a non-emphasized region of V^{k}(A) and letting s(H) denote the superset of H, defined as H union all open core segments incident to the core points in H. N(H) is defined as the union of all core elements owning Voronoi regions neighboring the regions of elements in s(H). The (weighted) L∞ Voronoi diagram of N(H)−s(H) is then computed and truncated within the interior of reg(H); this gives the (k+1)-order subdivision within reg(H). Each (k+1)-order subregion within reg(H) is attributed to a (k+1)-tuple H∪{c}, where cεN(H)−s(H). Once the (k+1)-order subdivision within reg(H) has been performed within the non-emphasized regions of V^{k}(A), the edges and vertices of V^{k}(A) that are not part of V^{k+1}(A) are removed. The incident (k+1)-order subregions of V^{k}(A) are merged into the (k+1)-order Voronoi regions of V^{k+1}(A), and the emphasized regions of V^{k+1}(A) are identified. Unlike the standard higher order Voronoi diagram case, not all Voronoi edges of V^{k}(A) are necessarily deleted from V^{k+1}(A). The details of this process are described in further detail below.

reg(H) is defined as a non-emphasized region of V^{k}(A), and c, c∉H is defined as a core element inducing a (k+1)-order subregion in reg(H). reg(H∪{c}) denotes the union of all (k+1)-order subregions of V^{k}(A) owned by H∪{c}. It is recalled that no (k+1)-order subdivision is performed within emphasized regions of V^{k}(A) (i.e., no portion of reg(H∪{c}) is emphasized other than potentially some bounding Voronoi edges. Any Voronoi element of V^{k}(A) in the interior of reg(H∪{c}) is deleted from V^{k+1}(A) (unless emphasized, as discussed below), and all subregions of reg(H∪{c}) are merged into a new (k+1)-order region of V^{k+1}(A). It thus remains to determine whether H∪{c} forms a cut for the biconnected component, B, such that cεB. There are at least two potential results.

In the first case, if reg (H∪{c}) is incident to an already emphasized Voronoi region reg(R) of V^{k}(A) such that R⊂H∪{c}, then H∪{c} clearly forms a cut for the biconnected component, B, such that cεB. reg (H∪{c}) is then emphasized and merged with reg(R). Since no portion of reg (H∪{c}) is already emphasized in V^{k}(A), it is not hard to see that the portion of V^{k}(A) in the interior of reg (H∪{c}) is, in fact, the corresponding portion of the farthest Voronoi diagram of R, V_{f}(R). The region of the cut, R, is said to expand into reg (H∪{c}), keeping the cut, R, as the sole owner of the expanded region. The portion of V^{k}(A) in the interior of reg (H∪{c}) remains as a finer subdivision of the expanded region.

In the second case, if reg (H∪{c}) is not incident to an already emphasized Voronoi region reg(R) of V^{k}(A) such that R⊂H∪{c}, it needs to be determined whether H∪{c} forms a new cut (i.e., whether reg H∪{c}becomes a new emphasized region of V^{k+1}(A), as discussed in greater detail below). If H∪{c} is, in fact, a new cut of the biconnected component, B, the cut, C, is defined as B∩(H∪{c}); the cut, C, is assigned as the owner of reg(H∪{c}), which is now denoted simply as reg(C), and reg(C) is emphasized. The interior of reg(C) is partitioned into finer subregions by V_{f}(C), the farthest Voronoi diagram of the cut, C, as given by the portion of V^{k}(A) in the interior of reg(C). No information is lost by assigning the cut, C, as the new owner of reg(H∪{c}), as no core element in (H∪{c})−c can be the farthest one among elements of H∪{c} for any point, tεreg(H∪{c}). In fact, any element of H that is not represented in the (complete) farthest Voronoi diagram of the cut, C, can be excluded from the cut, C.

The Voronoi diagram for opens on layer A has a size O(k(n−k)), where n denotes the number of polygonal edges on the layer, A, and k is the maximum number of iterations performed in the construction of the diagram until all regions are emphasized. This number, k, depends on the connectivity of the extended graph, G(N, A). This fact can be derived using the properties of standard higher order Voronoi diagrams of points, as taught by Lee, D. T. in “On k-nearest Neighbor Voronoi Diagrams in the Plane”, IEEE Trans. Comput. C-31(6), June 1982, pp. 478-487, which is herein incorporated by reference in its entirety.

A simple method to determine new cuts of V^{k+1}(A) allows reg(H) to be a non-emphasized region of V^{k}(A) and allows B to be a biconnected component associated with the set H (i.e., B∩H≠null, and there is a Voronoi edge bounding reg(H) induced by core elements b, h, such that bεB−H, and hεH). The elements H and B are removed, and the new non-trivial bridges, articulation points, and biconnected components of B−H are identified. For H∪{c} is thus a new cut of B if and only if c is a new non-trivial bridge or articulation point of B−H. It is then easy to identify any new cut associated with the non-emphasized Voronoi edges or vertices bordering reg(H) in V^{k}(A). It is noted that any new cut of V^{k+1}(A) corresponds to at least one Voronoi element of V^{k}(A).

The Voronoi diagram for opens on a VLSI layer, A, can be computed in time O(k²n log n) plus a total O(k²n²) time to determine cuts associated with higer order generators, where k is the maximum number of iterations performed, and n is the complexity of the layer, A. In the case where biconnected components form simple cycles, or where the maximum number, k, of iterations is bounded by k=2, the bound simplifies to O(n log n).

To identify the new cuts of V²(A) (i.e., generators of order two), a faster method could be obtained by partitioning biconnected components of the extended graph G(N, A) into triconnected components.

Once the set of cuts claiming a region in the Voronoi diagram for opens on layer A has been identified, the Voronoi diagram for opens can be interpreted as the Hausdorff Voronoi diagram of the set, as described by Papadopoulou et al. in “The Hausdorff Voronoi Diagram of Point Clusters in the Plane”, Algorithmica, 40, 2004, pp. 63-82, which is herein incorporated by reference in its entirety. Given a cut, C, and a point, t, the Hausdorff distance between the point, t, and the cut, C, simplifies to the maximum (weighted) distance of the point, t, from any core element in the cut, C (i.e., dₕ(t, C)=max{d_{w}(t, c), cεC}). The Hausdorff Voronoi diagram of a set, S, of cuts is the Voronoi diagram of the set, S, under the Hausdorff distance, where the Hausdorff Voronoi region of a cut, C, is reg(C)={t|dₕ(T, C)≦dₕ(x, Cⱼ), CⱼεS}. Assuming that some superset of cuts S ⊃C can be identified, the Hausdorff Voronoi diagram of the set, S, provides an alternative definition for the Voronoi diagram for opens on layer A. This observation may help reduce the number of iterations in computing the final Voronoi diagram for opens and speed up the construction in practice. Namely, once a sufficient set, S′, of cuts has been identified, the iterations can stop, and the Hausdorff Voronoi diagram of the set, S′, can be directly computed in the non-emphasized portion of the current V^{k}(A).

Furthermore, one can localize the higher order Voronoi diagram computation by applying the iterative process to identify cuts to each biconnected component independently. Computing the Hausdorff Voronoi diagram of cuts for all biconnected components union the first-order generators provides the Voronoi diagram for opens. Practical limits of the number of iterations for each biconnected can be easily imposed to gain speed with minimal (if any) potential loss in accuracy.

It is often desirable to compute one critical area value combining interconnected opens on layer A and via-blocks on the neighboring via layers into a single estimate of critical area for missing material defects. A via-block is a defect entirely destroying a connection (a via or cluster of vias) between neighboring conducting layers. The problem of computing critical area for via-blocks reduces to computing a Hausdorff Voronoi diagram of polygons representing clusters of redundant vias. To compute the combined Voronoi diagram for missing material defects, V(A) may simply be substituted with Vₕ(A′), the Hausdorff Voronoi diagram of all core elements of layer A union clusters of vias on the neighboring via layers. Voronoi regions of via-clusters represent via-blocks and are always emphasized in one embodiment. Vₕ(A′) can be computed by plane sweep by adapting the plane sweep construction taught by Papadopoulou et al. in “The Hausdorff Voronoi Diagram of Point Clusters in the Plane”, supra. The iterative process to compute new cuts and the final Voronoi diagram for missing material defects remain similar.

Referring back to FIG. 3, once the Voronoi diagram for opens is constructed, the method 300 proceeds to step 314 and computes the entire critical area integral in accordance with the Voronoi diagram. In one embodiment, the critical area integral is computed in accordance with the methods described by E. Papadopoulou (“Critical Area Computation for Missing Material Defects in VLSI Circuits”), supra. In particular, the critical area integral is discretized as a summation of simple terms derived from Voronoi edges. The method 300 then terminates in step 316.

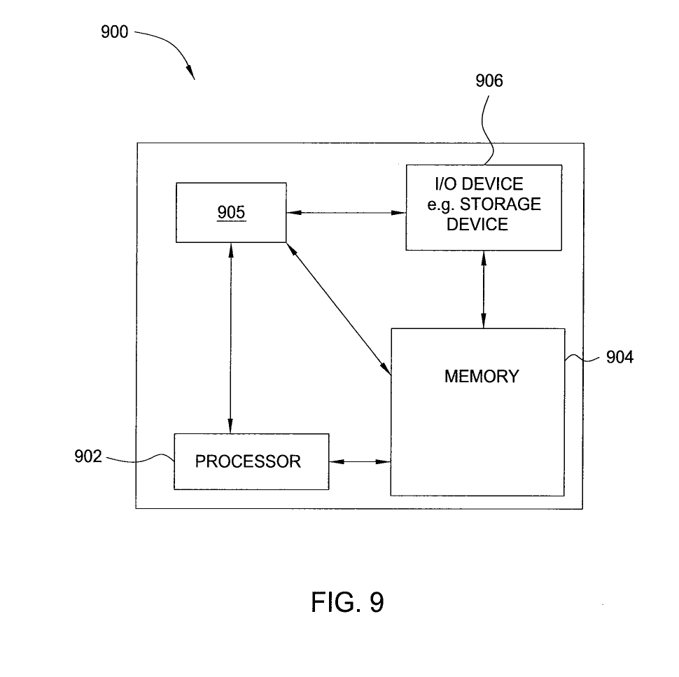

FIG. 9 is a high level block diagram of the present critical area computation method that is implemented using a general purpose computing device 900. In one embodiment, a general purpose computing device 900 comprises a processor 902, a memory 904, a critical area computation module 905 and various input/output (I/O) devices 906 such as a display, a keyboard, a mouse, a modem, and the like. In one embodiment, at least one I/O device is a storage device (e.g., a disk drive, an optical disk drive, a floppy disk drive). It should be understood that the critical area computation module 905 can be implemented as a physical device or subsystem that is coupled to a processor through a communication channel.

Alternatively, the critical area computation module 905 can be represented by one or more software applications (or even a combination of software and hardware, e.g., using Application Specific Integrated Circuits (ASIC)), where the software is loaded from a storage medium (e.g., I/O devices 906) and operated by the processor 902 in the memory 904 of the general purpose computing device 900. Thus, in one embodiment, the critical area computation module 905 for computing the critical area of VLSI chips described herein with reference to the preceding Figures can be stored on a computer readable medium or carrier (e.g., RAM, magnetic or optical drive or diskette, and the like).

Although the Figures discussed herein are depicted in Manhattan geometry for the purposes of simplicity, those skilled in the art will appreciate that the present invention is generally applicable to layouts of arbitrary geometry, as well as to other metrics of potential interest (e.g., Euclidean, k-gon, etc.).

Thus, the present invention represents a significant advancement in the field of VLSI devices. A method and apparatus are provided that enable a net-aware means of accurately computing critical area for opens, even in the presence of loops, ultimately enabling more efficient design of IC chips.

While foregoing is directed to the preferred embodiment of the present invention, other and further embodiments of the invention may be devised without departing from the basic scope thereof, and the scope thereof is determined by the claims that follow.

1. A method for determining the critical area of an integrated circuit, the method comprising the steps of:
modeling a net corresponding to the integrated circuit as a graph, the net comprising a plurality of interconnected shapes spanning one or more layers of the integrated circuit;
identifying one or more core elements in the graph, the core elements comprising at least one of: one or more bridges, one or more articulation points, and one or more biconnected components;
computing a first Voronoi diagram for a core portion of the graph on a selected one of the one or more layers, including the core elements;
emphasizing one or more regions in the first Voronoi diagram where a critical radius is known;
iteratively computing at least one higher-order Voronoi diagram in accordance with the emphasized one or more regions until a final Voronoi diagram for opens is derived; and
computing the critical area in accordance with the final Voronoi diagram for opens.

2. The method of claim 1, wherein the iteratively computing comprises:
emphasizing one or more additional regions in the at least one higher-order Voronoi diagram where a critical radius is known; and
re-computing the at least one higher-order Voronoi diagram.

3. The method of claim 2, wherein the steps of emphasizing the one or more additional regions and re-computing the higher-order Voronoi diagram are repeated until a user-defined iteration limit is reached.

4. The method of claim 3, further comprising:
computing a Hausdorff Voronoi diagram of cuts computed as of computation of a last-computed higher-order Voronoi diagram; and
deriving the final Voronoi diagram for opens from the Hausdorff Voronoi diagram.

5. The method of claim 2, wherein the steps of emphasizing the one or more additional regions and re-computing the at least one higher-order Voronoi diagram are repeated until substantially all regions of the at least one higher-order Voronoi diagram are emphasized.

6. The method of claim 1, wherein the step of computing the critical area comprises:
expanding the emphasized one or more regions in the final Voronoi diagram for opens.

7. The method of claim 1, wherein the emphasizing comprises:
emphasizing regions of the graph belonging to the one or more core elements.

8. The method of claim 1, wherein the identifying comprises:
partitioning the graph into the one or more bridges, the one or more articulation points, and the one or more biconnected components.

9. The method of claim 8, wherein the partitioning is performed in accordance with depth-first searching.

10. A computer readable medium containing an executable program for determining the critical area of an integrated circuit, where the program performs the steps of:
modeling a net corresponding to the integrated circuit as a graph, the net comprising a plurality of interconnected shapes spanning one or more layers of the integrated circuit;
identifying one or more core elements in the graph, the core elements comprising at least one of: one or more bridges, one or more articulation points, and one or more biconnected components;
computing a first Voronoi diagram for a core portion of the graph on a selected one of the one or more layers, including the core elements;
emphasizing one or more regions in the first Voronoi diagram where a critical radius is known;
iteratively computing at least one higher-order Voronoi diagram in accordance with the emphasized one or more regions until a final Voronoi diagram for opens is derived; and
computing the critical area in accordance with the final Voronoi diagram for opens.

11. The computer readable medium of claim 10, wherein the iteratively computing comprises:
emphasizing one or more additional regions in the at least one higher-order Voronoi diagram where a critical radius is known; and
re-computing the at least one higher-order Voronoi diagram.

12. The computer readable medium of claim 11, wherein the steps of emphasizing the one or more additional regions and re-computing the higher-order Voronoi diagram are repeated until a user-defined iteration limit is reached.

13. The computer readable medium of claim 12, further comprising:
computing a Hausdorff Voronoi diagram of cuts computed as of computation of a last-computed higher-order Voronoi diagram; and
deriving the final Voronoi diagram for opens from the Hausdorff Voronoi diagram.

14. The computer readable medium of claim 11, wherein the steps of emphasizing the one or more additional regions and re-computing the at least one higher-order Voronoi diagram are repeated until substantially all regions of the at least one higher-order Voronoi diagram are emphasized.

15. The computer readable medium of claim 10, wherein the step of computing the critical area comprises:
expanding the emphasized one or more regions in the final Voronoi diagram for opens.

16. The computer readable medium of claim 10, wherein the emphasizing comprises:
emphasizing regions of the graph belonging to the one or more core elements.

17. The computer readable medium of claim 10, wherein the identifying comprises:
partitioning the graph into the one or more bridges, the one or more articulation points, and the one or more biconnected components.

18. The computer readable medium of claim 17, wherein the partitioning is performed in accordance with depth-first searching.

19. Apparatus for determining the critical area of an integrated circuit, the apparatus comprising:
modeling a net corresponding to the integrated circuit as a graph, the net comprising a plurality of interconnected shapes spanning one or more layers of the integrated circuit;
identifying one or more core elements in the graph, the core elements comprising at least one of: one or more bridges, one or more articulation points, and one or more biconnected components;
computing a first Voronoi diagram for a core portion of the graph on a selected one of the one or more layers, including the core elements;
emphasizing one or more regions in the first Voronoi diagram where a critical radius is known;
iteratively computing at least one higher-order Voronoi diagram in accordance with the emphasized one or more regions until a final Voronoi diagram for opens is derived; and
computing the critical area in accordance with the final Voronoi diagram for opens.

20. The apparatus of claim 19, wherein the means for iteratively computing comprises:
means for emphasizing one or more additional regions in the at least one higher-order Voronoi diagram where a critical radius is known; and
means for re-computing the at least one higher-order Voronoi diagram.
